(19) United States
(12) Patent Application Publication
(10) Pub. No.: US 2025/0190288 A1
(43) Pub. Date: Jun. 12, 2025

(54) MULTI-CORE PROCESSOR USING INTERNAL DATA TRANSFER CIRCUIT AND POLLING MECHANISM FOR DATA TRANSFER BETWEEN MULTIPLE PROCESSOR CORES

(71) Applicant: Airoha Technology (Suzhou) Limited, Suzhou City (CN)

(72) Inventors: WEIHUA HUANG, Nanjing City (CN); Fei Yan, Nanjing City (CN)

(73) Assignee: Airoha Technology (Suzhou) Limited, Suzhou City (CN)

(21) Appl. No.: 18/970,826

(22) Filed: Dec. 5, 2024

(30) Foreign Application Priority Data
Dec. 12, 2023 (CN) 202311699347.5

(51) Int. Cl. G06F 9/54

(52) U.S. Cl. CPC G06F 9/544

(57) ABSTRACT

A multi-core processor includes a plurality of processor cores and a data transfer circuit. The processor cores include a first processor core and a second processor core. The first processor core has a first buffer, and writes a first data into the first buffer. The second processor core has a second buffer. The data transfer circuit performs a polling operation upon the first buffer to check if the first buffer has data waiting to be transferred, and transfers the first data from the first buffer to the second buffer, wherein the first data is transferred inside the multi-core processor only.

### BACKGROUND OF THE INVENTION

### 1. Field of the Invention

The present invention relates to a processor, and more particularly, to a multi-core processor that utilizes an internal data transfer circuit and a polling mechanism to realize fast data transfer between multiple processor cores.

### 2. Description of the Prior Art

A network processing unit (NPU) is a processor specially used for network packet processing. It has some features and architecture to accelerate the processing efficiency of network packets. When the NPU has multiple processor cores, the processing efficiency of network packets can be further improved through parallel processing. For example, characteristics of multiple processor cores can be used to perform pipelined parallel processing improving the forwarding efficiency of network packets. However, parallel processing using multiple processor cores requires data transfer between different processor cores. Generally speaking, due to power consumption and cost requirements, the NPU generally needs to use an external bus and an external memory to realize data transfer between different processor cores in the same multi-core processor. However, the external memory has a high access latency, that is, the access efficiency of the external memory is low. Performing data transfer between different processor cores through accessing an external memory via an external bus directly affects the overall packet forwarding processing efficiency.

### SUMMARY OF THE INVENTION

One of the objectives of the claimed invention is to provide a multi-core processor that utilizes an internal data transfer circuit and a polling mechanism to realize fast data transfer between multiple processor cores.

According to a first aspect of the present invention, an exemplary multi-core processor is disclosed. The exemplary multi-core processor includes a plurality of processor cores and a data transfer circuit. The processor cores include a first processor core and a second processor core. The first processor core has a first buffer, and is arranged to write a first data into the first buffer. The second processor core has a second buffer. The data transfer circuit is arranged to perform a polling operation upon the first buffer to check if the first buffer has data waiting to be transferred, and transfer the first data from the first buffer to the second buffer.

According to a second aspect of the present invention, an exemplary multi-core processor is disclosed. The exemplary multi-core processor includes a plurality of processor cores and a data transfer circuit. The processor cores include a first processor core and a second processor core. The first processor core has a first buffer. The second processor core has a second buffer, and is arranged to perform a polling operation upon the second buffer to check if the second buffer has data waiting to be read, and read a data from the second buffer. The data transfer circuit is arranged to transfer the data from the first buffer to the second buffer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a multi-core processor according to an embodiment of the present invention.

FIG. 2 is a diagram illustrating an operation of data transfer from one processor core to another processor core according to an embodiment of the present invention.

FIG. 3 is a flowchart illustrating internal data transfer in a multi-core processor that is performed by a data transfer circuit according to an embodiment of the present invention.

FIG. 4 is a diagram illustrating an operation of data transfer from one processor core to multiple processor cores according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

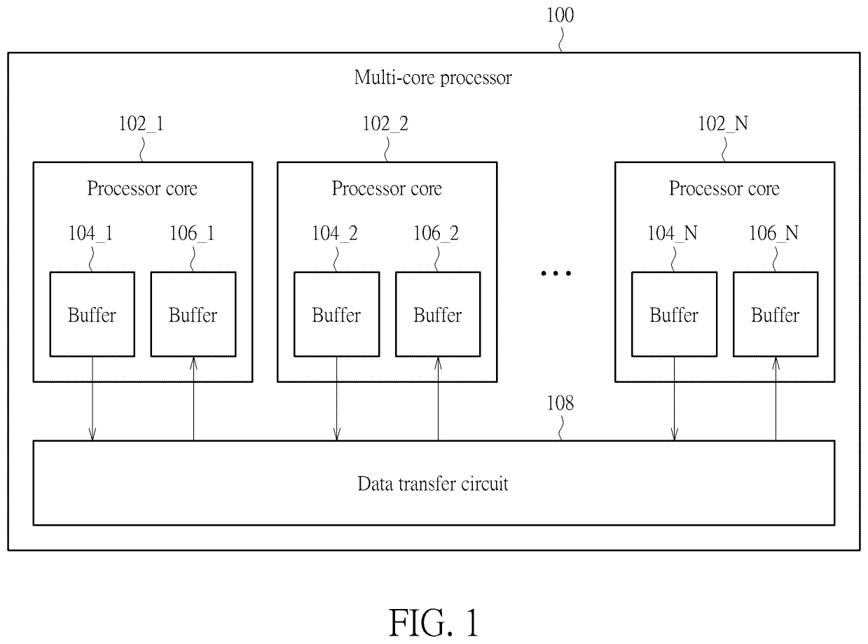

FIG. 1 is a diagram illustrating a multi-core processor according to an embodiment of the present invention. For example, the multi-core processor 100 may be a multi-core NPU without a shared cache, and may be employed by a network device such as a gateway. The multi-core processor 100 includes a plurality of processor cores 102_1, 102_2, . . . , 102_N (N≥2) and a data transfer circuit 108. The processor cores 102_1-102_N may have the same or similar processor architecture. As shown in FIG. 1, the processor core 102_1 includes a plurality of buffers 104_1 and 106_1 internally, the processor core 102_2 includes a plurality of buffers 104_2 and 106_2 internally, and the processor core 102_N includes a plurality of buffers 104_N and 106_N internally. In one example, the buffers 104_1-104_N and 106_1-106_N may be implemented by internal static random access memories (SRAMs) of processor cores 102_1-102_N. In another example, the buffers 104_1-104_N and 106_1-106_N may be first-in first-out (FIFO) buffers. It should be noted that only the components pertinent to the present invention are illustrated in FIG. 1. In practice, the multi-core processor 100 may include additional components to achieve designated functions.

In this embodiment, the buffers 104_1-104_N are used as transmit (TX) buffers, and the buffers 106_1-106_N are used as receive (RX) buffers. In other words, the processor core 102_i (1≤i≤N) can write the data to be transferred to another processor core 102_j (1≤j≤N,j≠i) into its own TX buffer (i.e., buffer 104_i), and the processor core 102_j can read the data transferred from the processor core 102_i through its own RX buffer (i.e., buffer 106_j). In addition, the processor core 102_i (1≤i≤N) can also write another data to be transferred to another processor core 102_k (1≤k≤N, k≠j, k≠i) into its own TX buffer (i.e., buffer 104_i), and the processor core 102_k can read the data transferred from the processor core 102_i through its own RX buffer (i.e., buffer 106_k). In this embodiment, the data transfer circuit 108 is designed to be responsible for dealing with data transfer between the processor cores 102_1-102_N. For example, the data transfer circuit 108 transfers one data in the buffer 104_i to the buffer 106_j, and transfers another data in the same buffer 104_i to the buffer 106_k. Since the data transfer circuit 108 is an internal circuit of the multi-core processor 100, data transfer between the processor cores 102_1-102_N does not need to go through an external bus and an external memory. In other words, the data transfer between the buffer 104_i and the buffer 106_j is performed inside the multi-core processor 100 only, and the data transfer between the buffer 104_i and the buffer 106_k is performed inside the multi-core processor 100 only. In this way, the data transfer efficiency between processor cores 102_1-102_N can be improved greatly. In addition, unlike the conventional multilevel cache hierarchy, the present invention achieves fast data transfer between different processor cores through internal buffers of the processor cores and a polling mechanism. When the multi-core processor 100 adopts the pipelined parallel computation architecture (i.e., processor cores 102_1-102_N are different pipeline stages of pipeline processing) to deal with the network packet forwarding task, the performance of network packet forwarding can be greatly improved. For example, a conventional multi-core processor takes about 14 clock cycles to perform one read operation upon an external SRAM, and takes about 7 clock cycles to perform one write operation upon the external SRAM. However, the multi-core processor 100 of the present invention only takes 1 clock cycle to perform one read operation upon the internal buffer 104_1-104_N and 106_1-106_N, and only takes one clock cycle to perform one write operation upon the internal buffer 104_1-104_N and 106_1-106_N.

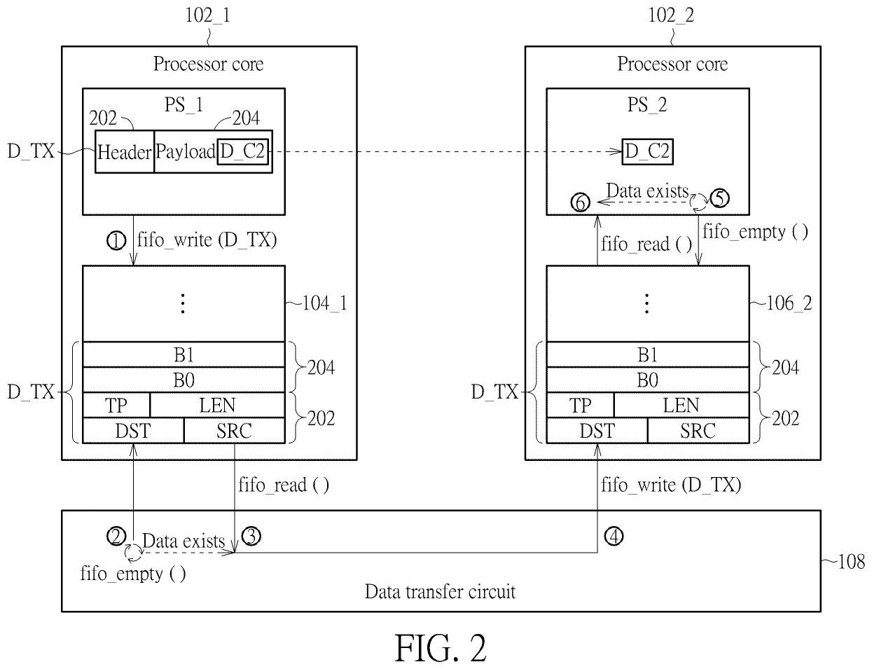

FIG. 2 is a diagram illustrating an operation of data transfer from one processor core to another processor core according to an embodiment of the present invention. It is assumed that the processor cores 102_1 and 102_2 are responsible for dealing with different pipeline stages PS_1 and PS_2 of pipeline processing, respectively, and the processor core 102_1 needs to transfer the processed data D_C2 of the pipeline stage PS_1 to the pipeline stage PS_2 for further processing. In this embodiment, the processor core 102_1 generates a transmission data D_TX, where the transmission data D_TX includes a header 202 and a payload 204, and the processed data D_C2 to be transferred to the processor core 102_2 is carried in the payload 204. The processor core 102_1 writes the transmission data D_TX into the buffer (e.g., FIFO buffer) 104_1 through the write instruction fifo-write(). The header 202 includes a plurality of fields used to record information about the data transfer operation. For example, the header 202 may include a DST field, an SRC field, a TP field and an LEN field, where the DST field is used to indicate the destination processor core of the transmission data D_TX (i.e., the DST field indicates which processor core that the transmission data D_TX is to be transferred to. In this embodiment, the DST field is set by Core 2 to indicate the transmission data D_TX is to be transferred to the processor core 102_2), and the SRC field is used to indicate the source processor core of the transmission data D_TX (i.e., the SRC field indicates which processor core that the transmission data D_TX is generated from. In this embodiment, the SRC field is set by Core 1 to indicate that the transmission data D_TX is sent from the processor core 102_1), the LEN field is used to indicate the data length of the payload 204 immediately following the header 202 (i.e., the LEN field indicates a data amount of the processed data D_C2 to be transferred to the processor core 102_2), and the TP field is used to indicate that the data carried by the payload 204 is to be processed by a designated function (i.e., the TP field indicates which function that the processed data D_C2 is to be processed by. In this embodiment, the TP field indicates one function of the pipeline stage PS_2). It should be noted that the above-mentioned fields are for illustrative purposes only, and are not meant to be limitations of the present invention. That is, fields included in the header 202 can be set according to actual requirements.

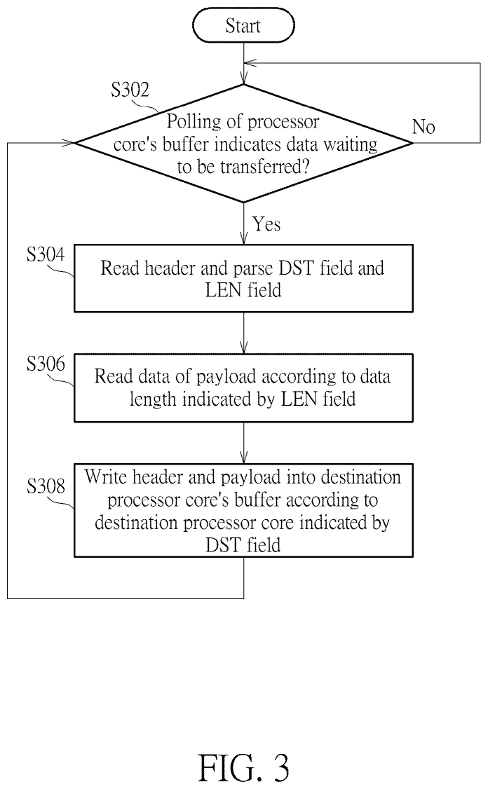

As mentioned above, the data transfer circuit 108 is responsible for dealing with data transfer between the processor cores 102_1-102_N. Please refer to FIG. 3 in conjunction with FIG. 2. FIG. 3 is a flowchart illustrating internal data transfer in a multi-core processor that is performed by the data transfer circuit 108 according to an embodiment of the present invention. Provided that the result is substantially the same, the steps are not required to be executed in the exact order shown in FIG. 3. At step S302, the data transfer circuit 108 executes the polling instruction fifo-empty() to check if the buffer of the processor core has data waiting to be transferred. In this embodiment, after the processor core 102_1 writes the transmission data D_TX into the buffer 104_1 through the write instruction fifo-write() the polling instruction fifo-empty() of the data transfer circuit 108 gets a response showing that the buffer 104_1 has data waiting to be transferred. Hence, the data transfer circuit 108 then executes the read instruction fifo_read() to read the header 202 of the transmission data D_TX, and parses fields in the header 202, such as the LEN field and the DST field (step S304). At step S306, the data transfer circuit 108 reads the data (e.g., two bytes B0 and B1) carried by the payload 204 immediately following the header 202 according to the data length indicated by the LEN field (e.g., LEN=2). At step S308, the data transfer circuit 108 executes the write instruction fifo_write() according to the destination processor core indicated by the DST field (e.g., DST=Core 2), to deliver the transmission data D_TX (which includes the header 202 and the payload 204) to the buffer (e.g., FIFO buffer) 106_2 in the processor core 102_2.

The buffer 106_2 is used as an RX buffer of the processor core 102_2. As shown in FIG. 2, the processor core 102_2 executes the polling instruction fifo-empty() to check if its own buffer 106_2 has data waiting to be processed/read. In this embodiment, after the data transfer circuit 108 writes the transfer data D_TX into the buffer 106_2 through the write instruction fifo-write() the polling instruction fifo-empty() of the processor core 102_2 gets a response showing that the buffer 106_2 has data waiting to be processed/read. Therefore, the processor core 102_2 then executes the read instruction fifo_read() to read the transmission data D_TX (which includes the header 202 and the load 204) in the buffer 106_2, and refers to the field (e.g., TP field) in the header 202 to perform related processing of the pipeline stage PS_2 upon the data carried by the payload 204 (i.e., the processed data D_C2 of the pipeline stage PS_1).

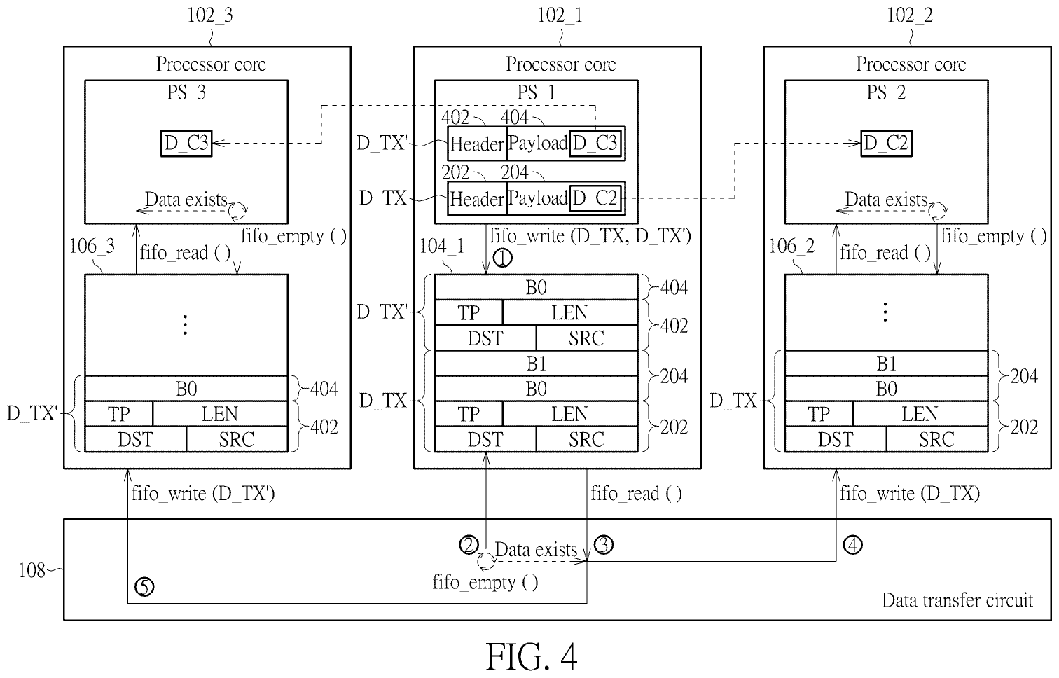

The buffers 104_1-104_N serve as TX buffers. In this embodiment, the same TX buffer (e.g., FIFO buffer) can be reused to temporarily store data to be transferred to different processor cores in sequence. In other words, each processor core does not need to allocate multiple TX buffers for different processor cores, which simplifies buffer configuration and maintenance. FIG. 4 is a diagram illustrating an operation of data transfer from one processor core to multiple processor cores according to an embodiment of the present invention. It is assumed that processor cores 102_1, 102_2, and 102_3 are responsible for dealing with different pipeline stages PS_1, PS_2, and PS_3 of the pipeline processing, respectively, and the processor core 102_1 needs to transfer the processed data D_C2 (which includes two bytes B0 and B1) of the pipeline stage PS_1 to the pipeline stage PS_2 for further processing, and transfer the processed data D_C3 (which includes one byte B0) of the pipeline stage PS_1 to the pipeline stage PS_3 for further processing. In this embodiment, the processor core 102_1 generates the transmission data D_TX and the transmission data D_TX′, where the transmission data D_TX includes the header 202 and the payload 204, and the transmission data D_TX′ includes the header 402 and the payload 404. In addition, the processed data D_C2 to be transferred to the processor core 102_2 is carried in the payload 204, and the processed data D_C3 to be transferred to the processor core 102_3 is carried in the payload 404. The processor core 102_1 sequentially writes the transmission data D_TX and D_TX′ into the buffer 104_1 through the write instruction fifo-write(). Next, the data transfer circuit 108 sequentially processes the transmission data D_TX and the transmission data D_TX′ stored in the same buffer 104_1 through the process shown in FIG. 3. That is, the data transfer circuit 108 first delivers the transmission data D_TX from the buffer (e.g., FIFO buffer) 104_1 of the processor core 102_1 to the buffer (e.g., FIFO buffer) 106_2 of the processor core 102_2, and then delivers the transmission data D_TX′ from the buffer (e.g., FIFO buffer) 104_1 of the processor core 102_1 to the buffer (e.g., FIFO buffer) 106_3 of the processor core 102_3.

The buffer 106_2 serves as an RX buffer of the processor core 102_2. As shown in FIG. 4, the processor core 102_2 executes the polling instruction fifo-empty() to check if the buffer 106_2 has data waiting to be processed/read. In this embodiment, after the data transfer circuit 108 writes the transmission data D_TX into the buffer 106_2 through the write instruction fifo-write(), the polling instruction fifo-empty() of the processor core 102_2 gets a response showing that the buffer 106_2 has data waiting to be processed/read. Therefore, the processor core 102_2 then executes the read instruction fifo_read() to read the transmission data D_TX (which includes the header 202 and the payload 204) in the buffer 106_2, and refers to the field (e.g., TP field) in the header 202 to perform related processing of the pipeline stage PS_2 upon the data carried by payload 204 (i.e., the processed data D_C2 of pipeline stage PS_1).

The buffer 106_3 serves as an RX buffer of the processor core 102_3. As shown in FIG. 4, the processor core 102_3 executes the polling instruction fifo-empty() to check if the buffer 106_3 has data waiting to be processed/read. In this embodiment, after the data transfer circuit 108 writes the transmission data D_TX′ into the buffer 106_3 through the write instruction fifo-write(), the polling instruction fifo-empty() of the processor core 102_3 gets a response showing that the buffer 106_3 has data waiting to be processed/read. Therefore, the processor core 102_3 then executes the read instruction fifo_read() to read the transmission data D_TX′ (which includes the header 402 and the payload 404) in the buffer 106_3, and refers to the field (e.g., TP field) in the header 402 to perform related processing of the pipeline stage PS_3 upon the data carried by the payload 404 (i.e., the processed data D_C3 of the pipeline stage PS_1).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-core processor comprising:
a plurality of processor cores, comprising:
a first processor core, comprising a first buffer, wherein the first processor core is arranged to write a first data into the first buffer; and
a second processor core, comprising a second buffer; and
a data transfer circuit, arranged to perform a polling operation upon the first buffer to check if the first buffer has data waiting to be transferred, and transfer the first data from the first buffer to the second buffer.

2. The multi-core processor of claim 1, wherein the plurality of processor cores further comprise:
a third processor core, comprising a third buffer;
the first processor core is further arranged to write a second data into the first buffer, and the data transfer circuit is further arranged to transfer the second data from the first buffer to the third buffer.

3. The multi-core processor of claim 1, wherein the first data comprises a header and a payload.

4. The multi-core processor of claim 3, wherein the header indicates that a destination processor core of the first data is the second processor core.

5. The multi-core processor of claim 3, wherein the header indicates a data length of the payload.

6. The multi-core processor of claim 3, wherein the header indicates that the payload is to be processed by a designated function.

7. The multi-core processor of claim 3, wherein the header indicates that a source processor core of the first data is the first processor core.

8. The multi-core processor of claim 1, wherein the first processor and the second processor core are arranged to deal with different pipeline stages of pipeline processing, respectively.

9. The multi-core processor of claim 1, wherein the multi-core processor is a multi-core network processing unit (NPU).

10. A multi-core processor comprising:
a plurality of processor cores, comprising:
a first processor core, comprising a first buffer; and
a second processor core, comprising a second buffer, wherein the second processor core is arranged to perform a polling operation upon the second buffer to check if the second buffer has data waiting to be read, and read a data from the second buffer; and
a data transfer circuit, arranged to transfer the data from the first buffer to the second buffer.

11. The multi-core processor of claim 10, wherein the data transfer circuit is further arranged to perform a polling operation upon the first buffer to check if the first buffer has data to be transferred.

12. The multi-core processor of claim 10, wherein the data comprises a header and a payload.

13. The multi-core processor of claim 12, wherein the header indicates that a destination processor core of the data is the second processor core.

14. The multi-core processor of claim 12, wherein the header indicates a data length of the payload.

15. The multi-core processor of claim 12, wherein the header indicates that the payload is to be processed by a designated function.

16. The multi-core processor of claim 12, wherein the header indicates that a source processor core of the data is the first processor core.

17. The multi-core processor of claim 10, wherein the first processor and the second processor core are arranged to deal with different pipeline stages of pipeline processing, respectively.

18. The multi-core processor of claim 10, wherein the multi-core processor is a multi-core network processing unit (NPU).
